(19) United States
(12) Patent Application Publication
(10) Pub. No.: US 2021/0367369 A1
(43) Pub. Date: Nov. 25, 2021

(54) ORNAMENTAL ELECTRICAL OUTLET COVER DEVICE

(71) Applicant: Lisa Thompson, Brookfield, WI (US)

(72) Inventor: Lisa Thompson, Brookfield, WI (US)

(21) Appl. No.: 16/878,306

(22) Filed: May 19, 2020

(51) Int. Cl. H01R 13/443; H02G 3/08

(52) U.S. Cl. CPC H01R 13/443; H02G 3/081

(57) ABSTRACT

An ornamental electrical outlet cover device includes an electrical outlet plug comprising a substantially planar element, the substantially planar elements having first and second planar, opposing surfaces and a design element comprising an attachment side and an ornamental design side. The first planar surface is configured as a place of attachment of the attachment side of the design element during intended use. The second planar surface includes at least one post element extending substantially perpendicularly from the second planar surface and configured to be inserted into an opening in the electrical receptacle to secure the ornamental electrical outlet cover device therein during intended use.

### BACKGROUND OF THE INVENTION

The invention broadly relates to electrical outlet covers and, relates more particularly to an ornamental electrical outlet cover device that is designed by users.

Electrical outlet devices are known. For example, U.S. Pat. No. 7,070,426 (“the prior art '426 patent”) discloses an electrical outlet child safety device, or cap, configured to include one or more openings in the shield of the safety cap to allow air to pass through to reduce or to substantially eliminate a choking hazard with the electrical outlet safety caps. The patent explains that standard electrical safety caps are made of insulating material, such as plastic, and include a shield portion and prongs, attached to the shield portion, and sufficiently spaced apart for insertion into two contact holes of an electrical outlet. When the prongs of the cap or device are fully inserted into the holes of the outlet, shield portion completely covers the contact holes of the electrical outlet. In this way, a child is unable to insert an object in the electrical outlet holes. The inventive shield of the child safety cap includes at least one opening, so that if a small child somehow puts it in his/her mouth, they likely can still receive air, if necessary through their mouth through the hole in the shield into their air passageway.

U.S. Pat. No. 8,212,146 (“the prior art '146 patent”) discloses a cover panel for electrical outlets that plugs into the holes of an unused electrical outlets and camouflages or conceals the receptacle and faceplate and creates a safety barrier to the electrical components of the unused safety outlet. The cover panel includes a solid panel front surface of non-conductive molded material for a paintable surface on the outside and posts adapted to be fit/inserted into the orifices/holes of the electrical socket on the inside. It appears from the figures that two posts, arranged vertically, are configured to be inserted into the ground holes associated with each receptacle of a duplex receptacle.

U.S. Design Pat. No. Des. 308,814 (“the prior art D814 patent”) discloses a decorative outlet and plug cover that includes two parts. The first part is the outlet part that is configured to cover the receptacle but for the actual outlets, and to include vertical edge portions, operating as grooves, that allow flange-like edge portions of the plug cover to be inserted into the vertical grooves and slide all the way in to cover the receptacles and slide out to uncover the receptacles. The outer surface of the plug cover is formed with a flower design, and a handle-like element understood to be intended to be used for grasping, to facilitate the sliding during intended operation.

U.S. Design Pat. No. Des. 222,262 (“the prior art D262 patent”) discloses and electrical outlet safety cap that has a circular design on one side, and two prongs and a post on the other side, assumedly configured for positioning in the holes for receiving the prongs, and the hole for receiving the ground post, in a conventional receptacle. It is assumed at least the prongs are made of non-conductive material. The circular design appears to be arranged in six, quasi-triangular sectors, in a size sufficient to cover one receptacle. A side view indicates that the sectors increase in thickness as a function of distance between the end edges of the circular design, and the center point, as shown.

While the aforementioned, and like prior art patents disclose devices that likely function to safely cover one or more receptacles, and the cover panel for the '146 patent allows a user to paint a design thereon, they all still bear resemblance to electrical receptacle covers. None suggest that such devices could be used not only as a safety device, but also as an ornamental electrical outlet cover device, which relies upon the openings in an electrical outlet as a means for mounting an ornamental device that has a footprint that is larger than the not only individual receptacles, but the entire outlet, still less where various ornamental cover art pieces can be attached to the cover plate, to a user's liking, to define the ornamental aspect.

### SUMMARY OF THE INVENTION

The present invention overcomes the shortcomings of the prior art.

In an embodiment, the invention provides an ornamental electrical outlet cover device. The devices includes an electrical outlet plug formed as a substantially planar element having first and second planar, opposing surfaces, with at least one post element extending substantially perpendicularly from the second planar surface and configured to be inserted into an opening in an electrical receptacle. Also includes is a design element comprising an attachment side and an ornamental design side, the attachment side configured as a place of attachment to the first planar surface of the electrical outlet plug, and attachment means arranged on the first planar surface of the electrical outlet plug, or the attachment side of the design element or both.

Preferably, the second planar surface of the electrical outlet plug includes at least two posts or prongs and attachment means comprises adhesive or Velcro or fasteners means. If an adhesive, the adhesive preferably is covered with a barrier that is peeled off at a time of intended use. If fasteners comprise any of the group consisting of screws, tacks, staples, magnets and complementary sleeves. Most preferably, one or both of the electrical outlet plug and the design element is made of non-conducting material. The design element displays a surface area coverage that is equal to or greater than a surface area coverage of the electrical outlet in which the plug is to be inserted during intended use. The attachment means is configured to support attachment to a design element that may weigh up to 2 pounds. If the design element is rectangular, it preferably includes a width of at least between 2 and 6 inches and a height of at least between 4 and 8 inches and if circular, the design element preferably includes a radius of at least between 2 and 6 inches.

In an embodiment, the invention embodies a combination of elements arranged in a kit. The kit consists essentially of an electrical outlet plug comprising a substantially planar element, the substantially planar element having first and second planar, opposing surfaces, and a plurality of design elements, each one of the plurality of design elements comprising an attachment side and an ornamental design side. The first planar surface of the electrical outlet plug and the attachment side of each one of the plurality of the design elements are configured to attached to each other during intended use. The second planar surface of the electric outlet plug includes at least one post element extending substantially perpendicularly from the second planar surface and configured to be inserted into an opening in the electrical receptacle to secure the ornamental electrical outlet plug with one of the plurality of design elements attached during intended use. The kit preferably further includes a container for holding the combination of elements. Each of the plurality of design elements is detachably attachable to the electrical outlet plug during intended use.

The invention also includes a method of utilizing an electrical outlet to omamentalize a space surrounding the electrical outlet. The method comprises certain steps, including, in a room, first choosing an electrical outlet proximate a wall space in need of ornamental improvement. Next, the ornamental design element is chosen from a set of different ornamental design elements that may have an effect of ornamentally improving the wall space proximate the electrical outlet. Then, the chosen ornamental design element is attached to a first planar surface of an electrical outlet plug. And then, the prongs extending perpendicularly from a second planar surface of the electrical outlet plug are inserted into the chosen electrical outlet, covering the electrical outlet.

Preferably, the step of next choosing includes choosing an ornamental design element with a particular size that defines a coverage surface area of the ornamental design element sufficient to cover a surface area of the electrical outlet into which the prongs are inserted. The coverage surface area is at least between 8 and 35 square inches. For that matter, the coverage surface area may be substantially circular with a radius equal to at least one half of a largest length or width of the electrical outlet, or if the electrical outlet is circular, equal to at least a radius of the circular electrical outlet.

### BRIEF DESCRIPTION OF THE DRAWINGS

The invention will be described in conjunction with the following drawings in which like reference numerals designate like elements and wherein:

FIG. 1 presents a side view of a first embodiment of an ornamental electrical outlet cover device 10, constructed in accordance with the invention;

FIG. 2A presents a perspective view of the electrical outlet plug of FIG. 1, highlighting the second planar surface and a pair of plugs extending therefrom;

FIG. 2B presents a view of the electrical outlet plug of FIG. 1 that provides manufacture dimensions in mm;

FIG. 2C presents a view of the electrical outlet plug of FIG. 1 that provides manufacture dimensions in mm;

FIG. 2D presents a view of the electrical outlet plug of FIG. 1 that provides manufacture dimensions in mm;

FIG. 2E presents a view of the electrical outlet plug of FIG. 1 that provides manufacture dimensions in mm;

FIG. 3A presents an ornamental side view of a substantially circular embodiment of the ornamental design element of FIG. 1;

FIG. 36 presents an ornamental side view of a substantially rectangular embodiment of the ornamental design element of FIG. 1;

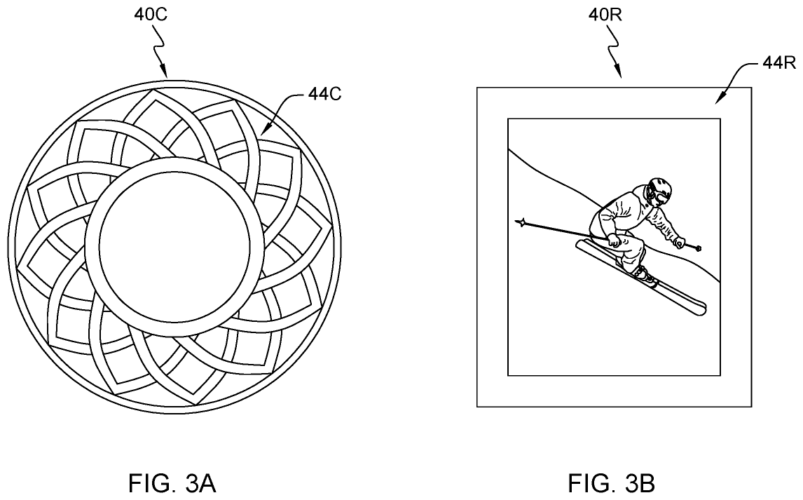

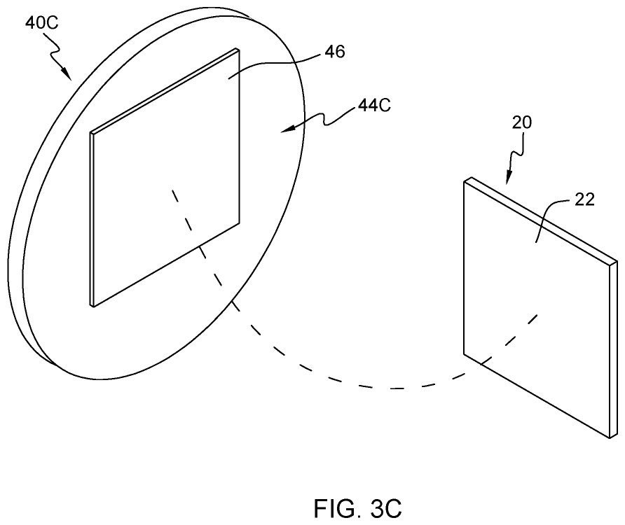

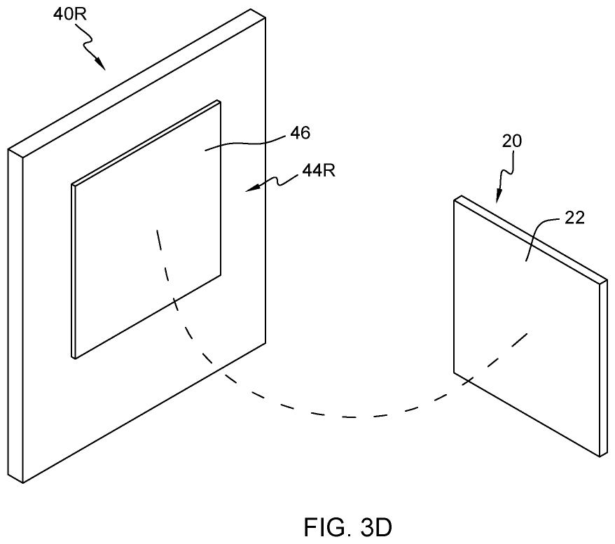

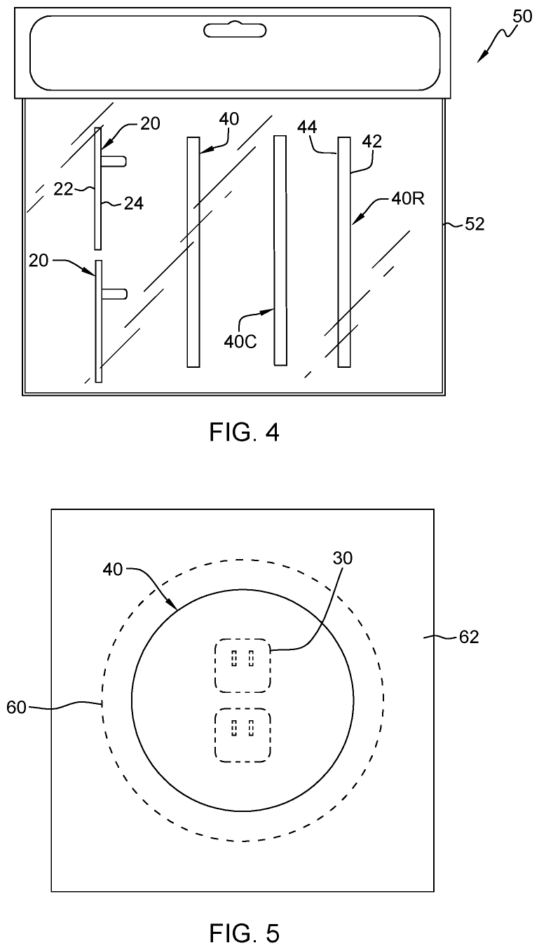

FIG. 3C depicts an attachment side and an attachment surface of the design element prior to attachment to a first planar surface of an electrical outlet plug;

FIG. 3D depicts an attachment side and attachment surface of a design element prior to attachment to a first planar surface of an electrical outlet plug;

FIG. 4 presents a representational view of a combination of at least one plug and design elements arranged in a kit; and

FIG. 5 presents a view of a wall in which the ornamental electrical outlet plug device is arranged after being assembled from a pre-assembled kit of elements.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

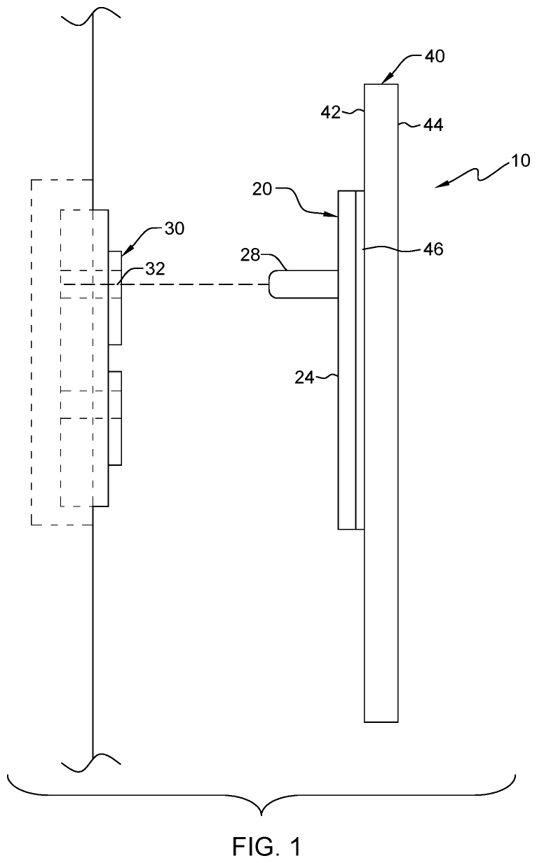

FIG. 1 depicts a first embodiment of an ornamental electrical outlet cover device 10, constructed in accordance with the invention. The ornamental electrical outlet cover device 10 includes an electrical outlet plug 20 formed as a substantially planar element having a first planar surface 22 and second planar surface 24, opposing the first planar surface. The second planar surface 24 is formed with at least one post element or prong 28 extending substantially perpendicularly from the second planar surface. The at least one post element or plug is configured to be inserted into an opening in an electrical receptacle. Preferably, the electrical outlet plug 20 includes two spaced apart prongs dimensioned to be received in prong openings 32 of a conventional electrical outlet 30.

The ornamental electrical outlet cover device 10 also includes a design element 40 comprising an attachment side 42 and an ornamental design side 44. A surface portion 46 of the attachment side 42 is configured as a place of attachment to the first planar surface 22 of the electrical outlet plug 20. Attachment means, such as adhesive, or an adhesive strip, is arranged on the first planar surface 22 of the electrical outlet plug 20 to attach the design element 40 to the electrical outlet plug 20, prior to inserting the plug into an electrical outlet. Alternatively, attachment means, such as adhesive or an adhesive strip, may be arranged on the attachment surface 46 on the attachment side 42 of the design element 40, to attached the design element to first planar surface 22 of the electrical outlet plug 20.

For that matter, adhesive may be arranged on both the attachment surface and on the first planar surface 22. The adhesive preferably is covered with a protective barrier, such as a paper element that is peeled off at a time of intended use. Most preferably, attachment is carried out prior to inserting the plug into an electrical outlet. Similarly, the attachment means may comprise Velcro, which requires complementary Velcro elements to be arranged on the respective attaching surface 46 and first planar surface 22.

Moreover, the attachment means may comprise conventional fasteners, such as screws, tacks, staples, magnets and complementary sleeves or grooves on either the plug or design elements, and complementary tongues for sliding therein, on either the plug or design elements, as known to the skilled artisan. Preferably, the attachment means is configured to support attachment to a design element that may weigh up to 2 pounds. Preferably, the design element is detachably connected to the electrical plug outlet during intended use.

As should be apparent to the skilled person, the one or both of the electrical outlet plug 20 and the design element 40 is manufactured from non-conducting material, such as known plastics or acrylics, or at least to be coated with non-conducting materials.

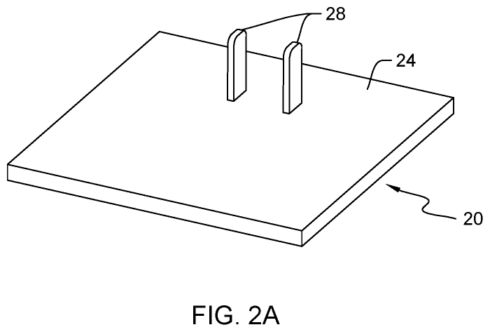

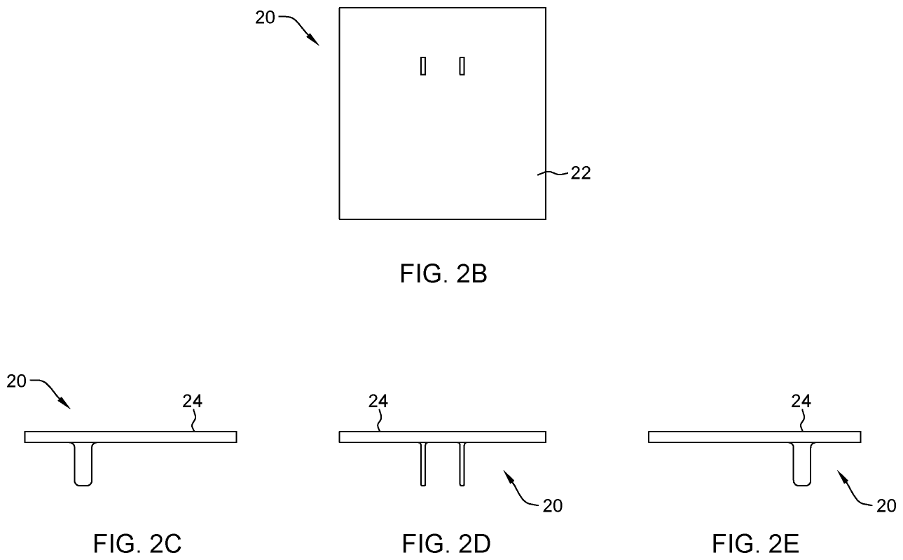

FIG. 2A presents a perspective view of the electrical outlet plug 20, highlighting the second planar surface 24, from which a pair of plugs 28 extends. FIGS. 2B, 2C, 2D and 2E provide very specific details of an embodiment of the electrical outlet plug 20, in mm. Please note that in the FIGS. 2B-2E embodiment, attaching means such as adhesive, a Velcro element or a fastener is not readily apparent.

FIGS. 3A and 3B depict substantially circular 40C and substantially rectangular 40R embodiments of the ornamental design element, respectively. The ornamental character is not limited to the design elements and respective surfaces 44C and 44R shown, which are presented for exemplary purposes only. For example, the surface 44R of design element 40R comprises a frame, glass and photo, and the surface 44C of the design element 40C comprises a circular artistic design. The options for the ornamental aspects are limitless. Preferably, each design element (e.g., 40, including 40C and 40R) displays a surface area coverage that is equal to or greater than a surface area coverage of the electrical outlet 30 in which the electrical outlet plug 20 is to be inserted during intended use. FIG. 3C depicts the attachment side 44C and attachment surface 46 of design element 40C prior to attachment to first planar surface 22 of electrical outlet plug 20. FIG. 3D depicts the attachment side 44R and attachment surface 46 of design element 40R prior to attachment to first planar surface 22 of electrical outlet plug 20.

Where the design element 40 is rectangular, it preferably is designed to have a width of at least between 2 and 6 inches and a height of at least between 4 and 8 inches, for example, a width or 4 inches and a height of 6 inches. Alternatively, the design element is rectangular and designed to have a width of at least between 4 and 8 inches and a height of at least between 2 and 6 inches, for example, a width of 7 inches and a height of 5 inches.

FIG. 4 depicts a combination of at least one plug and design elements arranged in a kit 50. That is, the kit 50 includes at least one electrical outlet plug 20 comprising a substantially planar element, the substantially planar element 40 having first 22 and second 24 planar, opposing surfaces and a plurality of design elements 40. Each of the design elements comprises an attachment side 42 and an ornamental design side 44. The first planar surface 22 of the electrical outlet plug 20 and the attachment side 42 of each one of the plurality of the design elements are configured to be attached to each other during intended use (see attachment surface 46 of attachment side 42). The second planar surface 24 of the electric outlet plug 20 includes at least one post element extending substantially perpendicularly therefrom and configured to be inserted into an opening 32 in the electrical receptacle 30 to secure the ornamental electrical outlet plug device 10 with one of the plurality of design elements 40 attached to the plug 20 during intended use. The kit further includes a container 50 for holding the combination of elements. As explained above, it is preferable that each of the plurality of design elements 40 is detachably attachable to the electrical outlet plug 20 during intended use.

The invention also includes a method of using the ornamental electrical outlet plug device 10 to ornamentalize a space 60 comprising part of a wall 62 surrounding an electrical outlet 30 (FIG. 5). The method comprises certain steps, including in a room, first choosing an electrical outlet 30 proximate a wall space 60 in need of ornamental improvement. Then, next choosing an ornamental design element 40 from a set of different ornamental design elements that may have an effect of ornamentally improving the wall space proximate the electrical outlet. Once done, the next step includes attaching the chosen ornamental design element to a first planar surface 22 of an electrical outlet plug 20 (preferably detachably attaching). Then, the method requires inserting prongs 28 extending perpendicularly from a second planar surface 24 of the electrical outlet plug 20 into the chosen electrical outlet, covering the electrical outlet.

The step of next choosing can include choosing an ornamental design element with a particular size that defines a coverage surface area of the ornamental design element sufficient to cover a surface area of the electrical outlet into which the prongs are inserted. Preferably, the coverage surface area is at least between 8 and 35 square inches. For that matter, where the coverage surface area is substantially circular with a radius equal to at least one half of a largest length or width of the electrical outlet, or if the electrical outlet is circular, at least a radius of the circular electrical outlet.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. An ornamental electrical outlet cover device, comprising:
an electrical outlet plug formed as a substantially planar element having first and second planar, opposing surfaces, with at least one post element extending substantially perpendicularly from the second planar surface and configured to be inserted into an opening in an electrical receptacle;
a design element comprising an attachment side and an ornamental design side, the attachment side configured as a place of attachment to the first planar surface of the electrical outlet plug; and
to attachment means arranged on the first planar surface of the electrical outlet plug, or the attachment side of the design element or both.

2. The ornamental electrical outlet cover device of claim 1, wherein the second planar surface of the electrical outlet plug includes at least two posts or prongs.

3. The ornamental electrical outlet cover device of claim 1, wherein the attachment means comprises adhesive or Velcro or fasteners.

4. The ornamental electrical outlet cover device of claim 3, wherein the adhesive is covered with a barrier that is peeled off at a time of intended use.

5. The ornamental electrical outlet cover device of claim 3, wherein the fasteners comprises any of the group consisting of screws, tacks, staples, magnets and complementary sleeves.

6. The ornamental electrical outlet cover device of claim 1, wherein one or both of the electrical outlet plug and the design element is made of non-conducting material.

7. The ornamental electrical outlet cover device of claim 1, wherein the design element displays a surface area coverage that is equal to or greater than a surface area coverage of the electrical outlet in which the plug is to be inserted during intended use.

8. The ornamental electrical outlet cover device of claim 1, wherein the attachment means is configured to support attachment to a design element that may weigh up to 2 pounds.

9. The ornamental electrical outlet cover device of claim 1, wherein the design element is rectangular and includes a width of at least between 2 and 6 inches and a height of at least between 4 and 8 inches.

10. The ornamental electrical outlet cover device of claim 1, wherein the design element is rectangular and includes a width of at least between 4 and 8 inches and a height of at least between 2 and 6 inches.

11. The ornamental electrical outlet cover device of claim 1, wherein the design element is circular, with a radius of at least between 2 and 6 inches.

12. The ornamental electrical outlet cover device of claim 1, wherein the design element is detachably connected to the electrical plug outlet during intended use.

13. A combination of elements arranged in a kit, the kit consisting essentially of:
an electrical outlet plug comprising a substantially planar element, the substantially planar element having first and second planar, opposing surfaces; and
a plurality of design elements, each one of the plurality of design elements comprising an attachment side and an ornamental design side;
wherein the first planar surface of the electrical outlet plug and the attachment side of each one of the plurality of the design elements are configured to attached to each other during intended use; and
wherein the second planar surface of the electric outlet plug includes at least one post element extending substantially perpendicularly from the second planar surface and configured to be inserted into an opening in the electrical receptacle to secure the ornamental electrical outlet plug with one of the plurality of design elements attached during intended use.

14. The combination of elements of claim 13, further including a container for holding the combination of elements.

15. A combination of elements of claim 13, wherein each of the plurality of design elements is detachably attachable to the electrical outlet plug during intended use.

16. A method of utilizing an electrical outlet to ornamentalize a space surrounding the electrical outlet, the method comprising the steps of:
in a room, first choosing an electrical outlet proximate a wall space in need of ornamental improvement;
next choosing an ornamental design element from a set of different ornamental design elements that may have an effect of ornamentally improving the wall space proximate the electrical outlet;
attaching the chosen ornamental design element to a first planar surface of an electrical outlet plug; and
inserting prongs extending perpendicularly from a second planar surface of the electrical outlet plug into the chosen electrical outlet, covering the electrical outlet.

17. The method of claim 16, wherein the step of next choosing includes choosing an ornamental design element with a particular size that defines a coverage surface area of the ornamental design element sufficient to cover a surface area of the electrical outlet into which the prongs are inserted.

18. The method of claim 17, wherein the coverage surface area is at least between 8 and 35 square inches.

19. The method of claim 17, wherein the coverage surface area is substantially circular with a radius equal to at least one half of a largest length or width of the electrical outlet, or if the electrical outlet is circular, at least a radius of the circular electrical outlet.
